(19) United States
(12) Patent Application Publication
(10) Pub. No.: US 2012/0094642 A1
(43) Pub. Date: Apr. 19, 2012

(54) ENHANCED MISSED CALL NOTIFICATION

(76) Inventors: Claudia Pöpperl, (US); Mathias O. Schrøder, (US); John G. Lisek, (US)

(21) Appl. No.: 12/905,442

(22) Filed: Oct. 15, 2010

(51) Int. Cl. H04M 3/42

(52) U.S. Cl. 455/415; 455/466

(57) ABSTRACT

An enhanced missed call notification system and method is disclosed which generates enhanced missed call notification messages, which may be transmitted by the cellular carrier, e.g. the carrier associated with the calling device, the called device, or both, to the user's cellular device using, for example, the SMS notification system, in which the notification message is augmented with additional information relating to the caller derived from sources which, for example, may provide more accurate information about the calling party or other information about the calling party, which may be more useful to the called party. In particular, the disclosed system and method detects that a user has missed a call, independent of the called device's ability to receive a call, identifies the caller, accesses one or more carrier-independent databases of information for additional information about the caller and generates an enhanced missed call notification message which includes the additional and/or more accurate information, or a reference thereto, and which is subsequently provided to the carrier for delivery to the user's cellular/mobile device using, for example, the SMS notification service.

### BACKGROUND

A common occurrence among cellular telephone users is a missed incoming call. Missed calls can occur when the user has their phone turned off, is out of range of a cellular tower, inadvertently misses the incoming call notification, is already on a call and has no call-waiting type service or has turned the service off, or simply chooses to ignore an incoming call at the time or by using a do-not-disturb type function. In Europe and other countries, it is common for the user's cellular phone carrier to detect the occurrence of a missed call and to send the user a Short Message Service (SMS or “text”) message to the user's cellular device, i.e. a missed call notification message, often including the telephone number of the caller, if available. In some cases, the caller name may also be provided in the notification when it can be derived from the carrier's records or the name may be provided by the called device when the called device is able to match the calling number from the incoming SMS message with an entry in a contacts database stored within the device. Where the user has a voice mail account associated with their device and the caller chooses to leave a message, the carrier may, instead of or in addition to a missed call notification, send a notification message indicating the presence of a new voice mail message. In the case where the user missed the call because, for example, their device was turned off or out of range, the SMS missed call notification will be queued for delivery by the carrier until such time as the user turns their phone back on or the phone is brought back into range of a cellular tower.

In the US, while new voice mail message notifications are commonly provided, SMS missed call notifications are less common and, instead, carriers, rely on the user's cellular device to detect and report when a call was received but not answered and the caller chose not to leave a voice mail. In such cases, the cellular device will capture the Automated Number Identification (“ANI”) data provided with the incoming call signal identifying the calling telephone number and report this information (and in some cases attempt to match the ANI data with the user's contact data stored in the phone to further identify the caller) to the user, often via a pop up message, audio alert or other indicator. However, in contrast to device based notifications, SMS based missed call notifications have the advantage of being queued in the store-and-forward based SMS system for delivery by the carrier to an unavailable device, thereby notifying the user of a missed call when their device itself is unaware that a call was even missed, e.g. because it was turned off or out of range at the time of the call.

### BRIEF DESCRIPTION OF THE DRAWINGS

FIG. 1 depicts an exemplary notification according to one embodiment.

FIG. 2 depicts an exemplary notification according to a second embodiment.

FIG. 3 depicts a block diagram of one implementation of an enhanced missed call notification system.

FIG. 4 depicts a more detailed block diagram of the enhanced missed call notification system of FIG. 3.

FIG. 5 depicts a more detailed block diagram of the enhanced missed call notification processor of FIG. 3.

FIG. 6 depicts a flow chart showing exemplary operation of the system of FIG. 3.

FIG. 7 depicts an exemplary implementation of the enhanced missed call notification processor of FIG. 5.

### DETAILED DESCRIPTION OF THE DRAWINGS AND PRESENTLY PREFERRED EMBODIMENTS

While missed call notifications are useful, merely knowing the telephone number of the caller, or even the caller's name, is often of limited utility to the called party, in particular when the name of the caller may be generic or inaccurately reflected in the limited database of the carrier. This may result in the call going unreturned, inconvenience for the both the calling and called parties and lost revenue for the carrier. The disclosed embodiments relate to a system and method for generating enhanced missed call notifications, which may be transmitted by a cellular /mobile carrier, e.g. the carrier associated with the calling device, the called device, or both, to the user's cellular/mobile device using, for example, the SMS notification system, in which the notification message is augmented with additional information relating to the caller derived from sources which, for example, may provide additional and/or more accurate information about the calling party or other information about the calling party, which may be more useful to the called party and/or indirectly beneficial to the calling party. Further, the utility and desirability of enhanced missed call notifications may provide for new revenue opportunities for the carrier. In particular, the disclosed embodiments relate to a system which detects that a user has missed a call, independent of the called device's ability to receive the call, identifies the caller, accesses one or more carrier-independent databases of information for additional and/or more accurate information about the caller and generates an enhanced missed call notification message which includes the additional and/or more accurate information, or a reference thereto, and which is subsequently provided to the carrier for delivery to the user's cellular/mobile device using, for example, the SMS notification service. While the disclosed embodiments related to missed incoming call notifications, more information regarding enhancing outgoing calls may be found in U.S. patent application Ser. No. 12/663,455, published as U.S. Patent Application Publication No. 2010/0166168 A1, entitled “CALL MANAGEMENT SYSTEM” now U.S. Pat. No. ______, herein incorporated by reference.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superceding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

A Short Message Service Center (“SMSC”) is a network element in a mobile telephone network which delivers Short Message Service (“SMS”) messages, also referred to as “text messages” or “texts.” While the below description of the SMS system generally relates to the implementation within a GSM based mobile telephone network, it will be appreciated that the disclosed embodiments may be utilized with CDMA, TDMA, Voice-over-IP and other types of mobile telephone systems now available or later developed. Generally, when a user sends a text message to another user, the message gets stored in the SMSC which delivers it to the destination user when they are available, i.e. when the destination device is turned on, within range of a cellular tower or otherwise capable of receiving transmissions, such as via WiFi or BlueTooth. The SMS system is a store and forward medium. An SMSC is responsible for handling the SMS operations of a wireless network. When an SMS message is sent from a mobile phone, it will reach an SMSC first. The SMSC then forwards the SMS message towards the destination. The main duty of an SMSC is to route SMS messages and regulate the process. If the recipient is unavailable (for example, when the mobile phone is switched off), the SMSC will store the SMS message. It will forward the SMS message when the recipient device is available.

The Short Message Service is realized by the use of the Mobile Application Part (“MAP”) of the SS#7 protocol, with Short Message protocol elements being transported across the network as fields within the MAP messages. These MAP messages may be transported using ‘traditional’ TDM based signaling, or over IP using SIGTRAN and an appropriate adaptation layer. The Short Message protocol itself is defined by 3GPP TS 23.040 for the Short Message Service—Point to Point (“SMS-PP”), and 3GPP TS 23.041 for the Cell Broadcast Service (“CBS”).

Four MAP procedures are defined for the control of the Short Message Service: 1. Mobile Originated (“MO”) short message service transfer; 2. Mobile Terminated (“MT”) short message service transfer; 3. Short message alert procedure; and 4. Short message waiting data set procedure. Regarding MT short message service transfer, the call flow generally, ignoring interactions between the Visited Mobile Switching Center (“VMSC”) and Visitor Location Register (“VLR”), and VMSC and Handset, includes: When the SMSC determines it needs to attempt to deliver a short message to its destination, it will send the SMS-PP Application Protocol Data Unit (“APDU”) containing the text message, the ‘B-Party’ (destination phone number), also referred to herein as the “called device,” and other details to the Gateway Mobile Switching Center (“MSC”) (GMSC) logical component on the SMSC. The GMSC, on receipt of this short message, needs to discover the location of the B-Party in order to be able to correctly deliver the text to the recipient (the term Gateway MSC, in this context, indicating an MSC that is obtaining routing information from the Home Location Register (“HLR”)). To do this, the GMSC invokes the MAP service package MAP_SEND_ROUTING_INFO_FOR_SM, which sends a sendRoutingInfoForSM (SRI-for-SM) MAP message to the destination number's HLR, requesting their present location. This SRI-for-SM message may be sent to an HLR in the same network as the SMSC, or via an interconnect to an HLR in a foreign PLMN, depending on which network the destination subscriber belongs to.

The HLR performs a database lookup to retrieve the B-Party's current location, and returns it in an acknowledgement message to the SMSC's GMSC entity. The current location may be the MSC address the subscriber is currently roaming on, the SGSN address, or both. The HLR may also return a failure, if it considers the destination to be unavailable for short messaging; see the Failed short message delivery section below.

Having obtained the routing information from the HLR, the GMSC will attempt to deliver the short message to its recipient. This is done by invoking the MAP_MT_FORWARD_SHORT_MESSAGE service, which sends a MAP mt-ForwardSMc message to the address returned by the HLR, regardless of whether it is an MSC (Circuit Switched SMS delivery) or an SGSN (Packet Switched SMS delivery).

The VMSC (addressed by the routing information returned by the HLR above) will request the information needed for it to deliver the Short Message to its recipient by sending a Send_Info_for_MT_SMS message to the VLR. The VLR will then instigate a page request, or subscriber search, for the destination subscriber's Mobile Subscriber ISDN Number (MSISDN), and return the result to the VMSC. Since a typical deployment sees the VLR being co-located with the MSC, this message flow is usually internal to the platform. Should the page or search for the subscriber fail, the VLR will indicate the failure cause to the VMSC which will abort the Short Message delivery procedure and return the failure to the SMSC (see the Failed short message delivery section below). If the page of the handset was successful, the VMSC will then send to the SMSC indicating successful delivery. The GMSC component of the SMSC passes the result of the delivery attempt to the Service Centre. In the case of successful delivery, the delivered text message will be removed from the Store and Forward Engine (SFE) and, if requested, a delivery report sent to the text originator. If the delivery failed, the SMSC invokes a retry procedure to periodically make further attempts at delivery; additionally, it may register with the HLR to receive a notification when the B-Party becomes available for short message delivery in the future (see the Failed short message delivery discussion below).

In the case of a failed short message delivery, when the VMSC/SGSN indicates a short message delivery failure, the SMSC may send a message to the HLR, using the MAP_REPORT_SM_DELIVERY_STATUS procedure, indicating the reason for the delivery failure and requesting that the SMSC be put on a list of service centers wanting to be notified when the destination party becomes available again. The HLR will set a flag against the destination account, indicating that it is unavailable for short message delivery, and store the SMSC's address in the Message Waiting Data (MWD) list for the destination party. Valid flags are Mobile Not Reachable Flag (MNRF), Memory Capacity Exceeded Flag (MCEF) and Mobile Not Reachable for GPRS (MNRG). The HLR will now start responding to SRI-for-SM requests with a failure, indicating the failure reason, and will automatically add the requesting SMSC's address to the MWD list for the destination party. (However if the SRI-for-SM message has priority flag set then the HLR will reply with VLR address if available).

The HLR may be informed of a subscriber becoming available for short message delivery in several ways: 1. where the subscriber has been detached from the network, a reattach will trigger a Location Update to the HLR; 2. where the subscriber has been out of coverage, but not fully detached from the network, on coming back into coverage it will respond to page requests from the VLR and the VLR will then send a Ready-for-SM (mobile present) message to the HLR; and 3. where the MS has had its memory full, and the subscriber deletes some texts, a Ready-for-SM (memory available) message is sent from the VMSC/VLR to the HLR.

Upon receipt of an indication that the destination party is now ready to receive short messages, the HLR sends an AlertSC MAP message to each of the SMSCs registered in the MWD list for the subscriber, causing the SMSC to start the Short Message delivery process again, from the beginning. Additionally, the SMSC will go into a retry schedule, attempting to periodically deliver the SM without getting an alert. The retry schedule interval will depend on the original failure cause—transient network failures will result in short retry schedule, whereas out of coverage will typically result in a longer schedule.

Generally, the disclosed embodiments relate to missed call notifications which notify the user of an unanswered call made to their cellular device. Such notifications may be implemented in at least two situations. One situation is where the caller does not leave a voice message in the called user's voice mail box or the called party does not even have voicemail. In this case most carriers just send out a message informing the user about the fact that number “xyz” tried to call. This may be done via SMS, MMS, electronic mail, instant message, audio message delivered to a voice mail box, a call or any other means of notification. The configuration when a missed call notification is sent out may vary from carrier to carrier and multiple options may be provided to the user. Some carriers may send a missed call notification out every time a call is missed. Some carriers may send them out only if the called party had no network coverage or the phone was switched off, but, for example, not in the case of a busy signal. The second situation is where the missed call notification informs the called party about the fact that someone left a voicemail message while he/she was not obtainable. In either scenario, the number of the caller can be identified and additional information, such as the caller's name, may be added to the missed call notification according to the disclosed embodiments. Generally, as used here, a missed call notification refers to a notification that the called party failed to answer the call of a calling party for any reason, regardless of whether the calling party leaves a voice mail message or not.

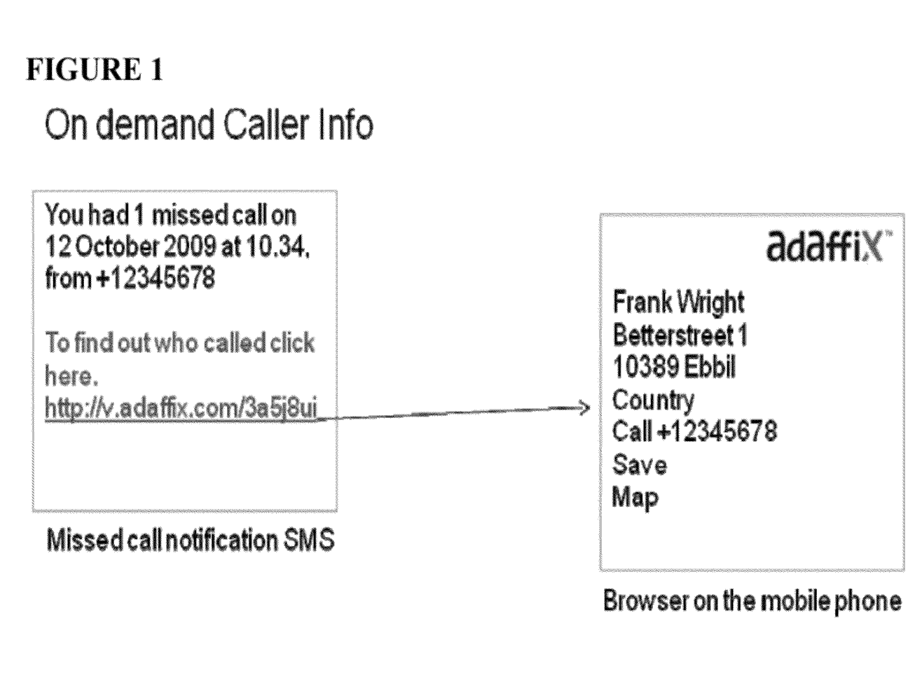

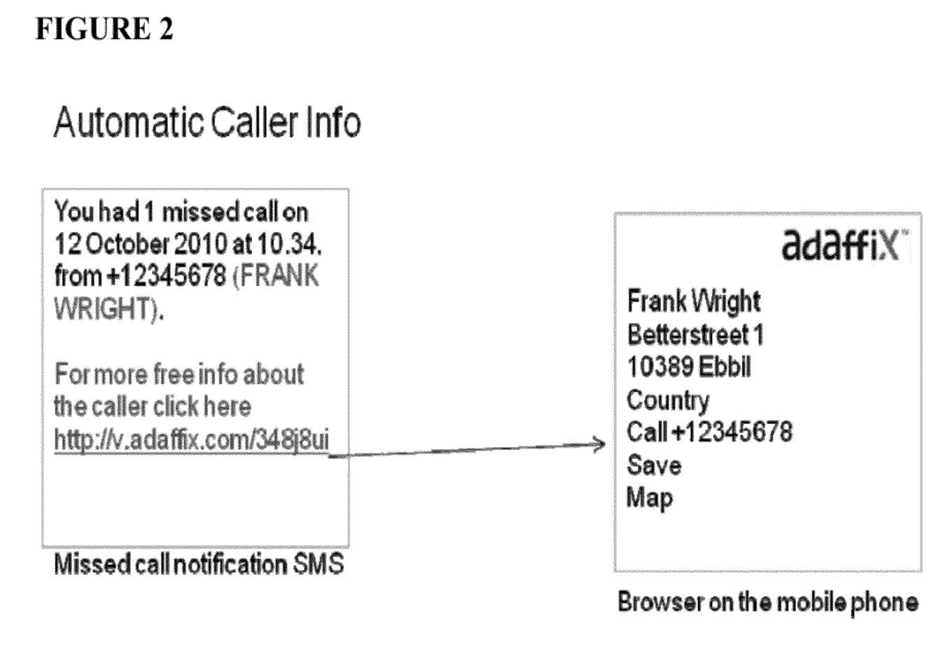

The disclosed embodiments provide for at least two types of enhanced missed call notifications, as shown be example if FIGS. 1 and 2. The first type, shown by example in FIG. 1 and referred to as “Automatic Caller Info,” automatically includes the name of the caller, and/or other additional information as will be discussed, in the missed call notification message to be displayed on the called device. The missed call notification may further include a Uniform Resource Identifier/locator/link (URL or URI) which, if selected/clicked on an appropriately enabled device, will open the device's mobile web browser and navigate automatically to a web page on which more information about the caller may be displayed. The link can refer, directly or indirectly, to a web site or particular web page provided by a third party information provider or aggregator, such as a site or page provided by adaffix, GmbH, or a site or web page provided by a carrier associated with the called device, or a web page or site provided by a directory publisher or to any other site e.g. a Facebook or Linkedin profile or a corporate web/mobile site. This type of notification may be available for a one time fee, on a subscription basis, as part of a service package offered by a carrier, or as a free service. In one embodiment, a telephone number, such as a toll-free telephone number, may be provided instead or in addition to the link allowing the user to call the number and receive the caller information audibly. Another type of enhanced missed call notification, shown by example in FIG. 2 and referred to as “On-demand Caller Info,” only display a “teaser” in the missed call notification that provides the user with the choice to find out who the caller was by clicking a URL/link and/or calling a telephone number provided in the notification. When the user clicks on the link, forwards the message via SMS or calls the telephone number, a billing event may happen (e.g. Premium SMS, WAP billing etc.) where by the user is charged for access to the additional information. On-demand Caller Info may be available for both pre-and post-pay subscribers. In implementations designed to work with limited capability devices, e.g. devices which do not have Internet access, the On-Demand Caller Info type may be used in a free mode similar to the Automatic Caller Info type. Either type of missed call notification may further include additional or supplemental information provided by the carrier and/or by the enhanced missed call notification service, such as advertisements, explanatory information, or other information and may include text, graphics, URL's, telephone numbers, etc. In one embodiment, where the calling party is a commercial entity, the additional information may include information relating to competitive entities determined as described herein.

The disclosed embodiments may provide users with the knowledge of ‘who called’, while helping carriers generate incremental revenue and may be offered as a subscription or as a premium SMS service and/or as an advertising based cost recovery medium. In the fast moving business environment of telecommunications operators, meeting evolving market and consumer expectations is vital. Every day people miss calls on their mobile phones. When this happens they may receive a standard notification via SMS but have no way of knowing who the caller is. The disclosed embodiments provide subscribers with transparency by including the caller's name, and/or other relevant, e.g. identifying information, etc.

In one embodiment, the system simply adds the additional/augmented information, such as the identity of the caller, to all missed call notifications. A standard notification “1 missed call from +49123456789” may become “1 missed call from Daniel Westway +49123456789”. There may also be a reference to a mobile page that holds more detailed information about the caller (or, as discussed below, this information may be directly inserted in the notification). The disclosed embodiments identify the additional information by doing, for example, a ‘number to name search’ against all the telephone and other databases it is connected to worldwide, independent of the carrier.

The disclosed embodiments improve customer satisfaction and improve call return rates by identifying missed calls, thereby removing the burden on the called party of looking up the caller's telephone number to try and figure out who called. Providing this solution may strengthen a carrier's market perception of service and reliability. The disclosed system can be offered to the network operator's entire customer base, as part of their service, on subscription basis and/or on a pay per use basis. It may work with any phone supporting SMS, including Internet enabled phones as well as legacy phones. Post-paid subscribers may use the disclosed system on a subscription basis; every missed call is automatically identified. Pre-paid customers may use the premium SMS service on an on demand basis.

In one embodiment, the system is the adaffix “Network Solution” manufactured by adaffix GmbH, located in Vienna, Austria, and offers increased top line revenue to carriers which would gain a lucrative revenue stream for missed call notification traffic. The disclosed system can be integrated into a network operator's infrastructure quickly. It may be offered in a carrier grade setup and integrated between the carrier's Voice Mail System (“VMS”) and the Short Message Service Center (“SMSC”). As will be described, the disclosed system may be integrated within the carrier's infrastructure, e.g. co-located at the carrier's site, or external thereto. The disclosed embodiments may be owned and operated by the carrier or offered to the carrier as a service.

Generally, the disclosed embodiments may be implemented as a hardware device logically integrated into the carrier network between the Voice Mail System (VMS) and the Short Message Service Centre (SMSC). Alternatively, the disclosed functionality may be implemented as computer program logic which runs a general purpose computer or on carrier implemented device, such as on the VMS or SMSC. Any VMS notification (sent out via SMS) will pass through the device and will be enriched with information as will be described. It will be appreciated that the disclosed embodiments need not be physically integrated with the carrier's infrastructure but, instead, may be located external to the carrier's infrastructure and logically connected thereto, such as by directing the VMS to redirect/reroute missed call notifications to the disclosed embodiments.

In particular, a device operating in accordance with the disclosed embodiments, may query a proprietary and/or publicly available server systems for additional information regarding the calling telephone number. In addition to this core functionality, the disclosed embodiments may integrate with the carrier's Subscriber Database in a subscription based implementation and with the carrier's Network Management Centre (NMC) and offer log and statistical functionality as well.

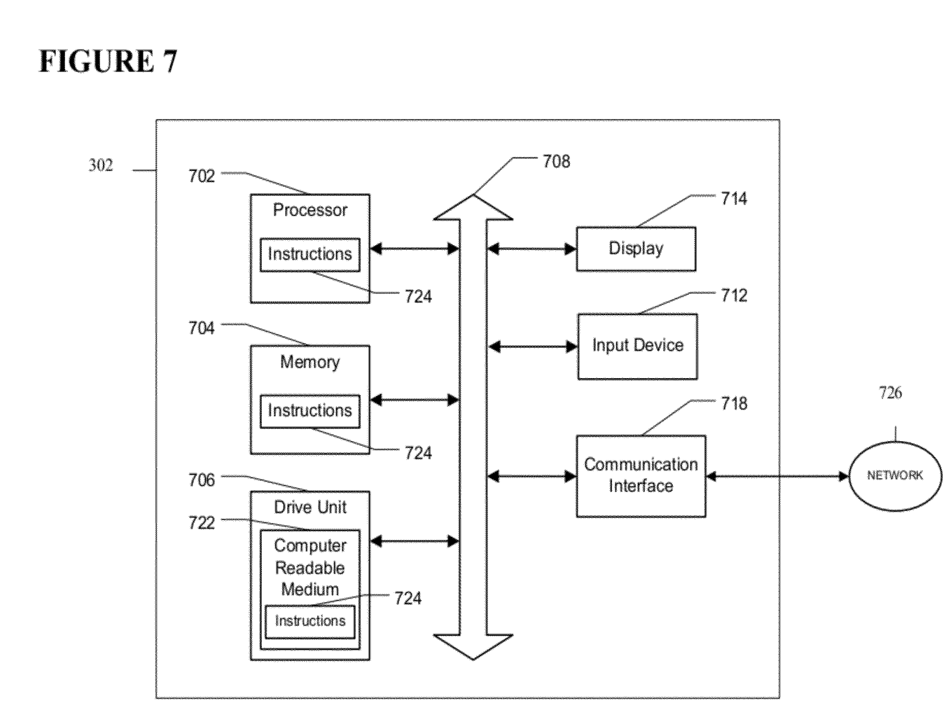

The adaffix box may use, for example, the Short Message Peer-to-Peer (SMPP) to interface to the VMS and the SMSC over a network, such as a public or private wired or wireless local area network, wide area network, or combination thereof and may include the network 726 described below with respect to FIG. 7. The SMPP protocol is a telecommunications industry protocol for exchanging SMS messages between SMS peer entities such as short message service centers and/or External Short Messaging Entities. It is often used to allow third parties (e.g. value-added service providers like news organizations) to submit messages, often in bulk. It will be appreciated that other communications protocols, now available or later developed, may also be supported, in addition to or instead of SMPP. For example, UCP, CIMD, EMI, OIS, or other HTTP-based protocols or any combination thereof can be used to interface to VMS and/or SMSC.

SMPP was originally designed by Aldiscon, a small Irish company that was later acquired by Logica (now split off and known as Acision). In 1999, Logica formally handed over SMPP to the SMPP Developers Forum, later renamed as The SMS Forum and now disbanded. As part of the original handover terms, SMPP ownership has now returned to Acision due to the disbanding of the SMS forum.

The protocol is based on pairs of request/response PDUs (protocol data units, or packets) exchanged over OSI layer 4 (TCP session or X.25 SVC3) connections. PDUs are binary encoded for efficiency.

In one implementation, the disclosed embodiments may use a hypertext transport protocol/eXtensible markup language (http/xml) interface to query data from the proprietary or publicly available servers via wired or wireless public or private local area or wide area network, such as the network 726 described with respect to FIG. 7. Depending on network operator needs, the interface to the NMC as well as potential log servers may further be adapted to carrier needs.

The disclosed embodiments may use a Linux-based platform and be deployed on carrier-grade server components to provide resiliency, redundancy and achieve carrier-grade standards. For more detail, refer to FIG. 7 and the accompanying description below. Further features of implementations of the disclosed embodiments may include: architecture to scale throughput from 1 sms/sec to 500+ sms/sec; graceful degradation on subsystem outages (for example, failure of internet connectivity shall not prevent VMS notifications); multipath SMS distribution (load balancing across multiple SMSCs); SMSC outage handling/re-routing; message segmentation for long SMS (larger than 160 characters); MSISDN-based queuing and in-order delivery of segments—modular protocol adaptors for SMPP, universal computer protocol (“UCP”), computer interface to message distribution (“CIMD”) and other protocols; local cache database for performance improvement including positive and negative caching; query throttling and quick pass-through path under overload conditions; and watchdog, system health and global queue monitoring.

In one embodiment, the adaffix Network Solution is implemented using the adaffix SMS Box (“ASB”) which is a component which may be coupled with a carrier's infrastructure, internally or external thereto, to enable enhancement of Voice Mail Notifications and support legacy devices which do not feature internet access capability or other “smart phone” capabilities. The ASB may be logically and/or physically integrated into the carrier network in between the Voice Mail System (“VMS”) and one or more Short Message Service Centers (“SMSC”) such that any VMS notification (sent out via SMS) will pass through ASB and will be enhanced as described herein. Upon receipt of a VMS notification, the ASB will query one or more designated server systems for the enhanced information. The ASB may further integrate with the carrier's Network Management Centre (“NMC”) so as to provide logging and statistical reporting functionality. The ASB integrates into the carrier network between VMS and SMSC and uses the SMPP protocol to interface to VMS and SMSC. An http/xml interface is used to query data from the designated information servers via a wired or wireless public or private local are or wide area network such as the network 726 described below with respect to FIG. 7. Depending on network operator needs, the interface to the NMC as well as potential log servers will be adapted to carrier needs.

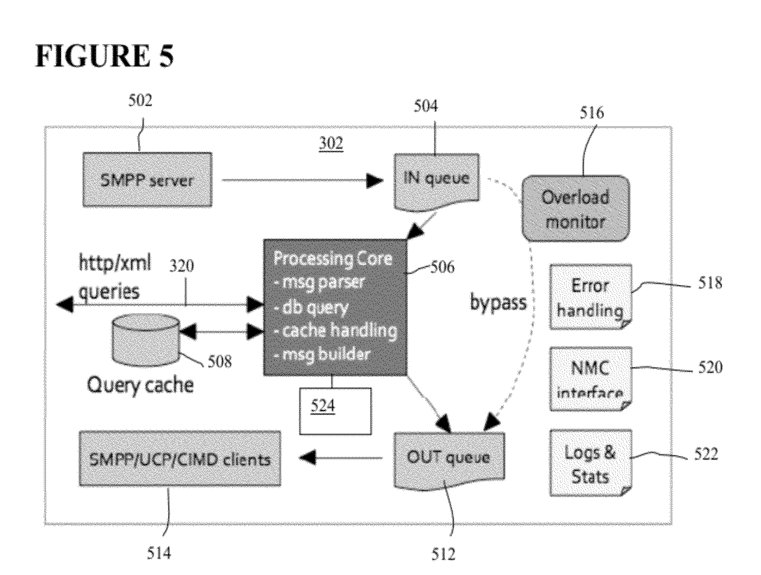

As will be described with respect to FIG. 5, the overall system design is based on a modular, layered architecture. Individual components can be exchanged easily, for example to adapt to different carrier needs. A queue management layer manages communication between software modules. This allows de-coupling from input, processing, and output interfaces. The redundant architecture is built by distributing these queues 504, 512 and can be used for active/standby redundancy systems. The SMPP server module 502 accepts incoming connections from the VMS system 306, receives messages and sends them to the “in queue” 504 for processing by the Processing Core 506. The Processing Core 506 features logic, such as computer program logic, executable to implement a message parser, an opt-in/opt-out check mechanism, a query logic, a local query cache, and a message builder to construct the resulting output message. The resulting message is then passed to the outbound drivers via the “out queue” 512. Outbound messaging is handled via the SMPP client module (or other protocol adaptors) 514 to the SMSC(s) 304. This module handles load-balancing to several SMSCs 304 and can provide fail-over routes in case of SMSC 304 or ASB outages to bypass notifications directly from the VMS 306 to the SMSC's 304 or to an alternate SMSC 304.

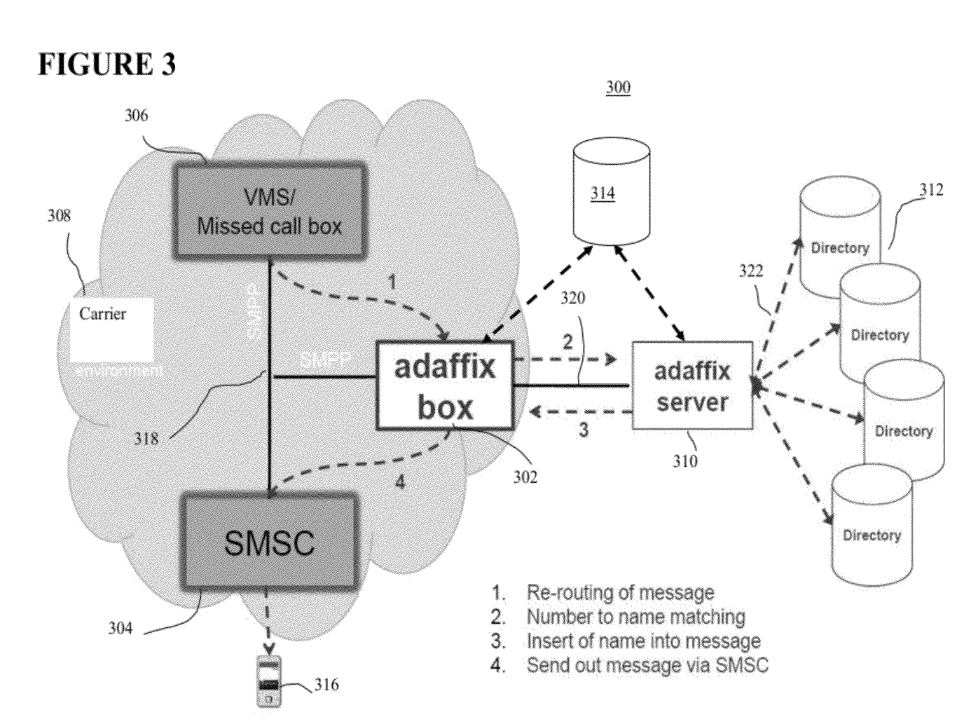

FIG. 3 depicts a block diagram of one implementation of the disclosed enhanced missed call notification system 300. As shown in the figure, the enhanced missed call notification processor 302 is coupled, logically and/or physically, between one or more SMSC's 304 and the VMS 306 of the carrier 308, using an SMPP or other protocol based connection 318, such as via an Ethernet or other wired or wireless network connection, such as the network 726 described below, so as to receive notifications of missed calls to devices 316 associated with the carrier 308. It will be appreciated that such notifications may be logically routed to the processor 302 or intercepted by the processor 302 in transit between the VMS 306 and the one or more SMSC's 304. The enhanced missed call notification processor 302 is further coupled with a query server 310 via a network 320, such as via a wired or wireless network 726, described in more detail below, which is further coupled with one or more data sources 312, via the same or a different network 322, which may be the network 726 described below. Herein, the phrase “coupled with” is defined to mean directly connected to or indirectly connected through one or more intermediate components. Such intermediate components may include both hardware and software based components. The enhanced missed call processor 302 may be further coupled with a local database/cache storage 314, either directly, via a network or otherwise, or via the query server 310, as will be described below. Operation of the system 300 will be described in more detail below. Generally in one exemplary implementation, however, notifications of missed calls may be provided by the VMS 306, or otherwise directed, to the enhanced missed call processor 302. Upon receipt of a missed call notification, which may include the telephone number of the calling device and, in one embodiment, the called device 316, from the VMS 306, the enhanced missed call processor signals the query server 310 and provides the telephone number of the calling device, and, in one embodiment, the called device. The query server 310 then queries the one or more data sources 312 for additional information relating to the telephone number of the calling device. This additional information is provided back to the query server 310 and to the enhanced missed call processor 302 which builds an SMS message including the additional information, or a reference thereto, addressed to the called device 316. This SMS message is then provided to the SMSC for delivery to the called device 316 via, for example, the connection 318.

In one embodiment, a local database/cache storage 314 may be provided, coupled either with the enhanced missed call processor 302 and/or the query server 310. In one implementation, this local database 314 is populated with telephone numbers for which it is known that data is not available in the one or more data sources 312. In this implementation, the local database 314 is first checked by the enhanced missed call processor 302 and/or query server 310, i.e. for “negative results,” prior to querying the one or more data sources 312 so as to avoid unnecessary delay in generating the enhanced missed call notification message. In one implementation, the local database 314 is queried in parallel with the one or more data sources 312 and the query to the data sources 312 is canceled or the results therefrom ignored when the local database 314 reports that data is not available in the data sources 312, i.e. the local database 314 is a “negative database.” In one implementation, the local database 314 is pre-populated with data regarding carrier subscribers for which data will not be found in the data sources 312, such as from a opt-out database or caller-ID block database. Alternatively, or in addition thereto, the local database 314 caches query results from the data sources 312 indicating that caller data was not found, thereby avoiding subsequent searches. In an alternative embodiment, the local database/cache storage 314 is pre-populated with and/or caches positive results received from the data sources 312, alone or in addition to negative results, to improve performance. In either case, processes may be implemented to ensure coherency of the cached data with the data sources 312.

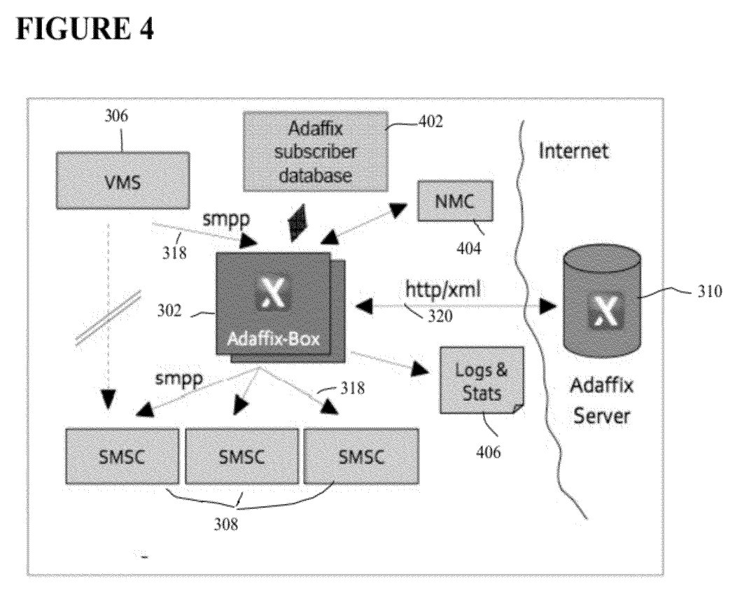

As shown in FIG. 4, the enhanced missed call processor 302 may further be coupled with a subscriber database 402, the carrier's network management center (“NMC”) 404 and log/statistical processor 406. In the case where enhanced missed call notifications are provided on a subscription basis, either by the calling party or the called party, the enhanced missed call processor 302 may first check the subscriber database 402 to determine whether or not the calling party, called party or both, have subscribed to the service. If so, an enhanced missed call notification may be generated and provided as described herein. If not, the missed call notification may be blocked or bypassed to the SMSC to be provided as a normal missed call notification. In one embodiment, a notice of the availability of the enhanced missed call notification service may be added to the missed call notification to alert the called party of the availability of such a service. Such a notice may follow the format of the on-demand notice described above. As was described above, the enhanced missed call processor may be further coupled with the carrier's NMC 404 and a log/statistical processor 406 for the purpose of reporting errors and operational metrics.

FIG. 5 shows a more detailed block diagram of the enhanced missed call processor 302. An exemplary implementation of the enhanced missed call notification processor 302 is described below with respect to FIG. 7. The enhanced missed call notification processor 302 includes an SMPP server 502 which interfaces with the VMS 306 using the SMPP protocol via the connection 318 as described above, an input queue 504 which buffers incoming missed call notifications, a processing core implementing the logic of the enhanced missed call processor 302 as will be described below, and a query cache 508 which buffers outgoing queries to the data sources 312 and, in one implementation may cache positive and/or negative results and may be the same as or separate from the local database/cache storage 314 described above. The enhanced missed call processor 302 further includes an http/xml query interface 510 for interfacing with the query server 310 via the network 320, a non-transitory memory/storage device 524, such as a random access or read only memory, which, in one implementation, stores the computer program logic executed by the processor to implement the disclosed functionality, an output queue 512 which buffers the outgoing enhanced missed call notifications and one or more SMPP, UCP, or CIMD clients 514 which interface with the one or more SMSC's 308 at the carrier(s) 308 via, for example the connection 318. The enhanced missed call notification processor 302 further includes an overload monitor 516, error handling logic 518, an interface to the carrier's NMC 404 and an interface to the log/statistical processor 406. In one embodiment, the overload monitor 516 monitors the input queue 504 and, based upon predefined performance thresholds/goals, bypasses the enhanced miss call processing for one or more of the queues missed call notifications, causing them to be moved directly to the output queue 512, or otherwise routed directly from the VMS 306 to the SMSC 304 so as not to impede message flow. In the case where an error is detected compromising the operations of the enhanced missed call processor 302, the overload monitor 516 may be directed, such as by the error handling logic 518, to bypass all missed call notifications, such as by bypassing them from the input queue 504 to the output queue 512 until the error can be corrected.

It will be appreciated that the disclosed embodiments may be implemented by the carrier associated with the calling device, the carrier associated with the called device, or both, or may be implemented in the calling device itself, such that calls from the calling device to the called device may be detected and notifications generated independent of the called device's ability to receive the call.

In one embodiment, the enhanced missed call notification processor 302 may include first logic, such as first computer program logic, stored in the memory 524 and executable by the processor 506 to receive an indication, such as from a carrier 308, VMS 306 or otherwise received or derived from the initiation of a telephone call by a calling device (not shown), indicative of a telephone call from a calling device to a called device 316. In one embodiment, the indication is received only after the call failed to be answered by the calling device. Alternatively, or in addition thereto, the indication may be received while the call is being initiated. The processor 506 is operative to receive the indication independent of the ability of the called device 316 to receive the call or the indication thereof, e.g. whether or not the called device 316 is turned on, within range or otherwise coupled with the missed call notification processor 302 at the time that the indication is received. In one embodiment, the processor 506 is located at the carrier associated with the called device 316, the calling device or both, e.g. within the carrier's infrastructure, or alternatively, at a third party location, such as at an enhanced missed call notification provider, or at the calling device itself.

It will be appreciated that the indication of a missed call may be generated, i.e. calls may be missed, because the called device 316 was unavailable to receive the call, e.g. the called device 316 was turned off, out of range or otherwise disconnected from the cellular network or otherwise did not have the capacity to receive the call, or because the user of the called device 316 was unaware of the call or chose to ignore the call. In one embodiment, the enhanced missed call processor 302 may detect the reason for the missed call and report this in a separate notification to the calling device. An indication of a missed call may be generated whether or not the calling party leaves a voice mail in a voice mail in box maintained by the carrier or maintained in the called device 316.

The indication further includes an identifier identifying the calling device. The indication may further include an identifier identifying the called device 316 and, in the case where the indication is provided by a carrier associated with either the calling device or the called device 316, the indication may include other information known to the carrier regarding the called device 316, the calling device or both, such as the registered account owner name, device type, etc. The identifier may include a telephone number assigned to the calling device. Alternatively, or in additional thereto, the identifier may include an Internet Protocol (IP) address, a MAC address, an Electronic Serial Number (ESN), or other identifier or combination thereof, assigned to or associated with the calling device. In one embodiment, the indication is provided by a VMS 306 of a carrier 308 via an SMPP interface 502 using the SMPP protocol which queues incoming indications in an input queue 504 for subsequent processing as described herein.

The enhanced missed call processor 302 further includes second logic, such as second computer program logic, stored in the memory 524 and executable by the processor 506 to determine, based on the identifier, at least one database 312 likely to comprise information associated with the identifier, wherein the database 312 is maintained independent of the carrier. The database 312 may be a telephone directory database maintained by third party directory service, such as Yellowpages, an Internet search engine, such as Google or Yahoo, social network database, such as Facebook, MySpace, 123people, LinkedIn, XING, or combination thereof. Where the identity of the registered owner of the calling device is determined, other database specific thereto may be used, such as the web site of an employer of the registered owner.

In one embodiment, the second logic is further executable by the processor to extract a country or other geographic indicator from the identifier, e.g. the country code, area code or prefix of a telephone number, and determine at least one database based on the geographic region comprising the country associated with the geographic indicator. Alternatively, or in addition thereto, the second logic may be further executable by the processor to determine a geographic location from where the call is originated wherein the enhanced missed call notification may further include the determined geographic location. Generally the second logic may further executable by the processor to determine a database likely to contain data relevant to the calling device, a registered owner of the calling device, or a combination thereof. In implementations which extract a geographic indicator of the location where the calling device is registered and/or presently being operative, the determined database may be limited to data associated with the determined geographic region. It will be appreciated that disclosed embodiments may not know who is actually operating the calling device but may only be able to determine the registered owner thereof. In one embodiment, a mechanism for reporting stolen devices may be provided such that when an indication of a call is received the call notification send to the called device 316 may indicate that the caller may not be the registered owner of the calling device or otherwise that the calling device was stolen.

The enhanced missed call processor 302 further includes third logic, such as third computer program logic, stored in the memory 524 and executable by the processor 506, to access the identified at least one database to retrieve at least a portion of the information associated with the identifier, e.g. information which is further associated with the calling device and/or a registered owner thereof. The retrieved information may, for example, comprise a name of the registered owner of the calling device, a home address of the registered owner of the calling device, a business address of the registered owner of the calling device, a website address associated with the registered owner of the calling device, an email address associated with the registered owner of the calling device, an instant messaging identifier associated with the registered owner of the calling device, a VoIP service identifier, such as a Skype ID, associated with the registered owner of the calling device, biographical information describing the registered owner of the calling device, demographic information describing the registered owner of the device, publicly available information relating the registered owner of the calling device, non-publicly available information relating to the registered owner of the calling device, information provided by the registered owner of the calling device, or a combination thereof.

The enhanced missed call processor 302 further includes fourth logic, such as fourth computer program logic, stored in the memory 524 and executable by the processor 506, to generate a notification of the call, the notification including the identifier and at least an indication of the retrieved information. In particular, in one embodiment, the indication of a missed call from the CMS 306 is parsed to extract the identifier, e.g. the calling device telephone number. This information may then be combined with the information retrieved from the data sources, or reference thereto, to create the enhanced missed call notification message. Other information, such as instruction text or advertisements, may also be included. In one embodiment, a template engine is provided which can be configured to generate the notifications using one or more templates which govern the notification format. This permits the system to support different languages and/or different carriers simultaneously where each carrier desires its own format, such as the inclusion of the carrier name or logo in the notification. In exemplary operation, this engine may: a) Determine in the message parser which language the original notification is by matching it to a set of defined rules; b) Find the template for the new notification based on the language of the original notification and also based on the result of the query (found a result/did not find a result); c) Expand the template by filling it with pieces from either the original message and/or from the query result; and d) Forward the constructed notification to the outbound queue.

In one embodiment, the fourth logic is further executable by the processor to provide the generated notification to a carrier associated with the called device, the calling device, or a combination thereof for transmission to the called device. In one exemplary implementation, the notification is queued in an outgoing queue 512 for transmission to one or more SMSC's 308 via an SMPP/UCP/CIMD interface 514. More than one SMSC 308 may be used to provide alternative delivery paths and/or redundant delivery paths to improve reliability and performance. In one embodiment, the notification may include a notation for inclusion on a billing statement associated with the called device, such as the identifications of the registered owner of the calling device, such that the call detail portion of the bill provides additional useful information. The notification may be an SMS message, an MMS message, an audio message, an electronic mail message, an instant message or other message type, or combination thereof.

The indication of the retrieved information included in the notification may comprise the retrieved information itself or at least a reference thereto which provides access to the retrieved information, such as a uniform resource locator, a telephone number, etc. In the case where only a reference to the retrieved information is provided, additional marketing information may be provided to instruct the recipient as to how to utilize the reference, whether there is a fee involved, etc. For example, access to the retrieved information may only be provided upon the agreement to pay a fee or as part of a subscription based service. In one embodiment, the enhanced missed call notification processor 302 is coupled with a subscription database 402 and the program logic described above is only performed when the called device 316 is registered in the subscription database as a subscriber. Otherwise, indications of the missed calls are bypassed.

In an alternative embodiment, opt-out database, not shown, may be provided allowing registered owners of calling devices to register to prevent the disclosed enhanced missed call notification processor 302 from providing additional information in the missed call notifications as described. In this case, the enhanced missed call notification processor 302 would check the opt-out database based on the identifier of the calling device and bypass the notification is the calling device is opted-out. This service may be provided for a fee to the registered owner of the calling device. In one embodiment, error handling logic 518 and overload monitoring 516 is provided to bypass notifications from the VMS 306 to the SMSC 304 in the event of malfunctions or excessive system load. This prevents the enhanced missed call notification processor 302 from becoming a bottleneck or otherwise impeding the carrier's ability to provide notification services to their customers.

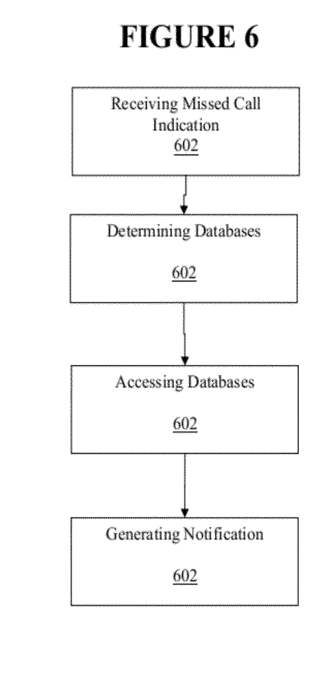

FIG. 6 depicts a flow chart showing exemplary operation of one implementation of the disclosed embodiments for providing call notifications, either initiated/incoming or missed. The exemplary operation includes: receiving, at a carrier, a third party processor or a calling device, an indication, either from a carrier or otherwise derived from a calling device, indicative of an initiated or missed telephone call from a calling device to a called device 316 (block 602), the indication further comprising an identifier identifying the calling device, such as a telephone number, IP address, MAC address, ESN, etc., the indication being received independent of the ability of the called device to receive the call or the indication thereof; and determining, based on the identifier, at least one database, maintained independent of a carrier, such as the carrier with which the calling device is associated, likely to comprise information associated with the identifier (block 604). In one embodiment, the determining may further include extracting a country or other geographic indicator from the identifier, such as the country code, the area code or the prefix, the determining further comprising determining the at least one database based on a geographic region associated with the geographic indicator to localize the determined databases. Alternatively, or in addition thereto, the geographic location where the calling device is actually located, based on the cellular network being utilized or based on Global Positioning System data, may be determined and utilized to localize the database determination. The geographic location where the calling device is registered and/or located may be included in the notification, as described below. Generally, the determining includes determining a database likely to contain data relevant to the calling device, a registered owner of the calling device, or a combination thereof. The determined data base may include a telephone directory database, such as Yellowpages, an Internet search engine, such as Google or Yahoo, a corporate web site or database, such as a web site associated with the registered owner of the calling device, a social network database, such as Facebook, MySpace, 123people, LinkedIn, Xing, or a combination thereof. The retrieved information may include a name of the registered owner of the calling device, a home address of the registered owner of the calling device, a business address of the registered owner of the calling device, a website address associated with the registered owner of the calling device, biographical information describing the registered owner of the calling device, demographic information describing the registered owner of the device, publicly available information relating the registered owner of the calling device, non-publicly available information relating to the registered owner of the calling device, information provided by the registered owner of the calling device, or a combination thereof.

The operation of the enhanced missed call notification processor 302 further includes: accessing the identified at least one database to retrieve at least a portion of the information associated with the identifier (block 606); and generating a notification of the call, the notification including the identifier and at least an indication of the retrieved information (block 608). The operation may further include providing the generated notification to a carrier associated with the one of the called device, the calling device, or a combination thereof for transmission to the called device. In one embodiment, the notification is an SMS message. Alternatively, or in addition thereto, the notification may be an MMS message, an audio message, an electronic mail message, an instant message, or a combination thereof. In one embodiment, the notification comprises a notation for inclusion on a billing statement associated with the called device, for example, to enhance the call detail portion of the customer's bill.

The indication of the retrieved information may be the retrieved information and/or a reference thereto, such as Uniform Resource Locator or telephone number, where the reference is operable to provide access to the retrieved information, for free, for a one-time fee, or on a subscription basis.

FIG. 7 illustrates a general computer system 700, which may represent the enhanced missed call notification processor 302, or any of the other computing devices referenced herein. The computer system 700 may include a set of instructions 724, such as the computer program logic described above, that may be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 724 (sequential or otherwise) that specify actions to be taken by that machine. In a particular embodiment, the computer system 700 may be implemented using electronic devices that provide voice, video or data communication. Further, while a single computer system 700 may be illustrated, the term “system” shall also be taken to include any collection of systems or sub-systems that individually or jointly execute a set, or multiple sets, of instructions to perform one or more computer functions.

As illustrated in FIG. 7, the enhanced missed call notification processor 302 may include a processor 702, such as, a central processing unit (CPU), a graphics processing unit (GPU), or both. The processor 702 may be a component in a variety of systems. For example, the processor 702 may be part of a standard personal computer or a workstation. The processor 702 may be one or more general processors, digital signal processors, application specific integrated circuits, field programmable gate arrays, servers, networks, digital circuits, analog circuits, combinations thereof, or other now known or later developed devices for analyzing and processing data. The processor 702 may implement a software program, such as code generated manually (i.e., programmed).

The enhanced missed call notification processor 302 may include a memory 704 that can communicate via a bus 708. The memory 704 may be a main memory, a static memory, or a dynamic memory. The memory 704 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 704 may include a cache or random access memory for the processor 702. Alternatively or in addition, the memory 704 may be separate from the processor 702, such as a cache memory of a processor, the system memory, or other memory. The memory 704 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 704 may be operable to store instructions 724 executable by the processor 702. The functions, acts or tasks illustrated in the figures or described herein may be performed by the programmed processor 702 executing the instructions 724 stored in the memory 704. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The enhanced missed call notification processor 302 may further include a display 714, such as a liquid crystal display (LCD), an organic light emitting diode (OLED), a flat panel display, a solid state display, a cathode ray tube (CRT), a projector, a printer or other now known or later developed display device for outputting determined information. The display 714 may act as an interface for the user to see the functioning of the processor 702, or specifically as an interface with the software stored in the memory 704 or in the drive unit 706.

Additionally, enhanced missed call notification processor 302 may include an input device 712 configured to allow a user to interact with any of the components of the enhanced missed call notification processor 302. The input device 712 may be a number pad, a keyboard, or a cursor control device, such as a mouse, or a joystick, touch screen display, remote control or any other device operative to interact with the enhanced missed call notification processor 302.

The enhanced missed call notification processor 302 may also include a disk or optical drive unit 706. The disk drive unit 706 may include a computer-readable medium 722 in which one or more sets of instructions 724, e.g. software, can be embedded. Further, the instructions 724 may perform one or more of the methods or logic as described herein. The instructions 724 may reside completely, or at least partially, within the memory 704 and/or within the processor 702 during execution by the enhanced missed call notification processor 302. The memory 704 and the processor 702 also may include computer-readable media as discussed above.

The present disclosure contemplates a computer-readable medium 722 that includes instructions 724 or receives and executes instructions 724 responsive to a propagated signal; so that a device connected to a network 726 may communicate voice, video, audio, images or any other data over the network 726. Further, the instructions 724 may be transmitted or received over the network 726 via a communication interface 718. The communication interface 718 may be a part of the processor 702 or may be a separate component. The communication interface 718 may be created in software or may be a physical connection in hardware. The communication interface 718 may be configured to connect with a network 726, external media, the display 714, or any other components in system 700, or combinations thereof. The connection with the network 726 may be a physical connection, such as a wired Ethernet connection or may be established wirelessly as discussed below. Likewise, the additional connections with other components of the enhanced missed call notification processor 302 may be physical connections or may be established wirelessly.

The network 726 may include wired networks, wireless networks, or combinations thereof. The wireless network may be a cellular telephone network, an 802.11, 802.16, 802.20, or WiMax network. Further, the network 726 may be a public network, such as the Internet, a private network, such as an intranet, or combinations thereof, and may utilize a variety of networking protocols now available or later developed including, but not limited to TCP/IP based networking protocols.

The computer-readable medium 722 may be a single medium, or the computer-readable medium 722 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 722 may include a solid-state memory such as a memory card or other package that houses one or more non-volatile read-only memories. The computer-readable medium 722 also may be a random access memory or other volatile re-writable memory. Additionally, the computer-readable medium 722 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

In one embodiment, the enhanced missed call processor 302 is implemented using a Dell® PowerEdge® R410 server having at least one Intel® Xenon® E620 Quad Core processor (4×2.4 GHz, 12 MB L3 Cache, Intel® Turbo Boost and Hyper-Threading technologies), 4 GB of RAM, two one-terabyte 7200 RPM SATA hard drives in a RAID 1 configuration, Gigabit Ethernet and executing the Ubuntu 10.04 operating system. Alternatively, the disclosed embodiments may be implemented in a blade form factor and operable to be inserted in a suitable blade enclosure provided by a carrier and integrated with the carrier's network infrastructure, such as an IBM Bladecenter enclosure manufactured by IBM Corp.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be substantially minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method of providing notification of a call, the method comprising:
receiving an indication indicative of a telephone call from a calling device to a called device, the indication further comprising an identifier identifying the calling device, the indication being received independent of the ability of the called device to receive the call or the indication thereof;
determining, based on the identifier, at least one database, maintained independent of a carrier associated with the calling device, which comprises information associated with the identifier;
accessing the identified at least one database to retrieve at least a portion of the information associated with the identifier; and
generating a notification of the call, the notification including the identifier and at least an indication of the retrieved information.

2. The method of claim 1 wherein the receiving further comprises receiving the indication by a device connected with a carrier associated with the calling device, the called device or a combination thereof.

3. The method of claim 1 further comprising:
providing the generated notification to a carrier associated with the one of the called device, the calling device, or a combination thereof for transmission to the called device.

4. The method of claim 1 wherein the notification comprises a notation for inclusion on a billing statement associated with the called device.

5. The method of claim 1 wherein the notification comprises an SMS message, an MMS message, an audio message, an electronic mail message, an instant message or a combination thereof.

6. The method of claim 1 wherein the indication from the carrier indicates that the call has been initiated by the calling device to the called device.

7. The method of claim 1 wherein the indication from the carrier indicates that the called device failed to answer the call.

8. The method of claim 7 wherein the called device is unavailable at the time of the call.

9. The method of claim 7 wherein an operator of the called device failed to answer the call.

10. The method of claim 1 wherein the identifier comprises a telephone number assigned to the calling device.

11. The method of claim 10 wherein the determining further comprises extracting a country indicator from the telephone number, the determining further comprising determining the at least one database based on a geographic region comprising the country associated with the country indicator.

12. The method of claim 1 wherein the determining further comprises determining a database likely to contain data relevant to the calling device, a registered owner of the calling device, or a combination thereof.

13. The method of claim 12 wherein contents of the determined database are limited to data associated with the determined geographic region.

14. The method of claim 1 wherein the determined database comprises a telephone directory database.

15. The method of claim 1 wherein the determined database comprises an Internet search engine.

16. The method of claim 1 wherein the determined database comprises a social network database.

17. The method of claim 16 wherein the social network database comprises Facebook, MySpace, 123people, LinkedIn, XING or a combination thereof.

18. The method of claim 1 wherein the retrieved information comprises a name of the registered owner of the calling device, a home address of the registered owner of the calling device, a business address of the registered owner of the calling device, a website address associated with the registered owner of the calling device, biographical information describing the registered owner of the calling device, demographic information describing the registered owner of the device, publicly available information relating the registered owner of the calling device, non-publicly available information relating to the registered owner of the calling device, information provided by the registered owner of the calling device, or a combination thereof.

19. The method of claim 1 wherein the indication of the retrieved information comprises the retrieved information.

20. The method of claim 1 wherein the indication of the retrieved information comprises at least a reference to the retrieved information, the reference operable to provide access to the retrieved information.

21. The method of claim 20 wherein the reference comprises a URL.

22. The method of claim 20 wherein the reference comprises a telephone number.

23. The method of claim 20 wherein the reference provides access to the retrieved information for a fee.

24. A system for providing notification of a call, the system comprising a processor and a memory coupled with the processor, the system further comprising:
first logic stored in the memory and executable by the processor to receive an indication of a telephone call from a calling device to a called device, the indication further comprising an identifier identifying the calling device, the processor being operative to receive the indication independent of the ability of the called device to receive the call or the indication thereof;
second logic stored in the memory and executable by the processor to determine, based on the identifier, at least one database which comprises information associated with the identifier, the at least one database maintained independent of a carrier associated with the calling device;
third logic stored in the memory and executable by the processor to access the identified at least one database to retrieve at least a portion of the information associated with the identifier; and
fourth logic stored in the memory and executable by the processor to generate a notification of the call, the notification including the identifier and at least an indication of the retrieved information.

25. The system of claim 24 further comprising an interface coupled with the processor and the memory and operative to couple the system with a carrier associated with the calling device, the called device or a combination thereof.

26. The system of claim 24 wherein the fourth logic is further executable by the processor to provide the generated notification to a carrier associated with the called device, the calling device, or a combination thereof for transmission to the called device.

27. The system of claim 24 wherein the notification comprises a notation for inclusion on a billing statement associated with the called device.

28. The system of claim 24 wherein the notification comprises an SMS message, an MMS message, an audio message, an electronic mail message, an instant message or a combination thereof.

29. The system of claim 24 wherein the indication from the carrier indicates that the call has been initiated by the calling device to the called device.

30. The system of claim 24 wherein the indication from the carrier indicates that the called device failed to answer the call.

31. The system of claim 30 wherein the called device is unavailable at the time of the call.

32. The system of claim 30 wherein an operator of the called device failed to answer the call.

33. The system of claim 24 wherein the identifier comprises a telephone number assigned to the calling device.

34. The system of claim 33 wherein the second logic is further executable by the processor to extract a country indicator from the telephone number, and determine the at least one database based on the geographic region comprising the country associated with the country indicator.

35. The system of claim 24 wherein the second logic is further executable by the processor to determine a database likely to contain data relevant to the calling device, a registered owner of the calling device, or a combination thereof.

36. The system of claim 35 wherein contents of the determined database are limited to data associated with the determined geographic region.

37. The system of claim 24 wherein the determined database comprises a telephone directory database.

38. The system of claim 24 wherein the determined database comprises an Internet search engine.

39. The system of claim 24 wherein the determined database comprises a social network database.

40. The system of claim 39 wherein the social network database comprises Facebook, MySpace, 123people, LinkedIn, XING or a combination thereof.

41. The system of claim 24 wherein the retrieved information comprises a name of the registered owner of the calling device, a home address of the registered owner of the calling device, a business address of the registered owner of the calling device, a website address associated with the registered owner of the calling device, biographical information describing the registered owner of the calling device, demographic information describing the registered owner of the device, publicly available information relating the registered owner of the calling device, non-publicly available information relating to the registered owner of the calling device, information provided by the registered owner of the calling device, or a combination thereof.

42. The system of claim 24 wherein the indication of the retrieved information comprises the retrieved information.

43. The system of claim 24 wherein the indication of the retrieved information comprises at least a reference to the retrieved information, the reference operable to provide access to the retrieved information.

44. The system of claim 43 wherein the reference comprises a URL.

45. The system of claim 43 wherein the reference comprises a telephone number.

46. The system of claim 43 wherein the reference provides access to the retrieved information for a fee.

47. A system for providing notification of a call, the system comprising:
means for receiving an indication of a telephone call from a calling device to a called device, the indication further comprising an identifier identifying the calling device, the means for receiving being capable of receiving the indication independent of the ability of the called device to receive the call or the indication thereof;
means for determining, based on the identifier, at least one database maintained independent of a carrier, which comprises information associated with the identifier;
means for accessing the identified at least one database to retrieve at least a portion of the information associated with the identifier; and
means for generating a notification of the call, the notification including the identifier and at least an indication of the retrieved information.
